(19) United States
(12) Patent Application Publication
(10) Pub. No.: US 2005/0091036 A1
(43) Pub. Date: Apr. 28, 2005

(54) Method and apparatus for a hierarchical object model-based constrained language interpreter-parser

(76) Inventors: Hazel Shackleton, Blaine, MN (US); Christopher J. Misiak, Phoenix, AZ (US)

Correspondence Address: HONEYWELL INTERNATIONAL INC., Law Dept. AB2, P.O. Box 2245, Morristown, NJ, 07962-9806, US

(21) Appl. No.: 10/692,112

(22) Filed: Oct. 23, 2003

(51) Int. Cl. G06F 17/27

(52) U.S. Cl. 704/9

(57) ABSTRACT

A natural language parser creates parsed commands or output for an external system from user commands entered on a user interface. The parser utilizes symbols arranged in an object-oriented hierarchical manner, and a grammar information and state table to constrain language inputs so that they conform to requirements of the external system. The parser provides feedback to the user via the user interface to assist in the formation of valid output to the external system and reduce the complexity for the user. The parser may be applied to the field of control systems in general, as well as a flight control system for an aircraft.

### BACKGROUND OF THE INVENTION

1. Field of the Invention

The invention relates to the field of language interpreters and more specifically to a natural language interpreter based on a hierarchical object model. Such language processors may be used to simplify the human interface with a controller for a vehicle, machine, or any other mechanism that uses a controller.

2. Description of the Related Art

Complex systems requiring advanced controls have proliferated in recent decades. Traditional user interfaces (e.g., keyboard, graphical display) and appertaining software has been used to interact with these controls. As a result of the increased system and control complexity, these systems typically require fairly extensive training for the user and also require constant use by the user in order to maintain proficiency.

This is particularly true in the aircraft cockpit, where there has been much concern about the usability of aircraft flight management systems (FMS). Concerns in this field range from the amount of training time required, as described by Wiener, E. (1989), Human factors of advanced technology (“glass cockpit”) aircraft, Moffett Field: NASA Contractor Report 177528, to errors and difficulty understanding them, such as those described by Sarter, N., and Woods, D. (1991), User interaction with cockpit automation: Operational experiences with the flight management system (FMS), The Ohio State University, Columbus, Ohio.

Much of the recent work attempting to resolve problems related to complexity has focused on developments utilizing increased flexibility of graphical formats to provide more hand-holding through operational procedures, including pop-up menus, dialog boxes, and other tools. However, in many situations, it is not the interface itself that makes the complex controllers difficult to use, but is rather the complexity of the underlying functional logic.

As an illustrative example, in the field of aircraft control, when a user learns to use an FMS, he or she must learn and commit to memory a large set of procedures and operating rules. Many of these involve mode logic as described by Sherry, L., and Poulson, P. (1998). “Implications of Situation-Action Rule Description of Avionics Behavior” HCI-Aero 1998, Montreal, Quebec, but many others involve the basic steps required for performing FMS functions. For example, the steps required to build a holding pattern around an unpublished waypoint are generally not intuitive, and if a user has not performed the procedure recently, it can take several minutes of trial and error before he or she finds the correct path through the interaction logic.

To address this control complexity in the context of aircraft control systems, U.S. Pat. No. 6,346,892 ('892), herein incorporated by reference, discloses a method and apparatus for aircraft systems management that employs a Cockpit Control Language (CCL) using an operational logic that users are already familiar with (the content and syntax of air traffic control (ATC) clearances as the basis for FMS interaction logic. This permits the user to avoid having to learn a new, apparently arbitrary, set of rules governing the operation of a complex system. In other words, this allows the system to work like the user thinks rather than have the user think like the system works.

An interface and system for aircraft control and based on this principle is described in Riley, V. (2000). “Developing a User-Centered Autoflight Interface” Proceedings of the World Aviation Congress, San Diego, Calif., which demonstrates that users could learn to use such a system in about fifteen minutes. During the training time, users were trained to enter a required time of arrival crossing restriction over a waypoint and hold around an unpublished waypoint with minimal help. For example, to execute a clearance command, “Hold at twenty miles before Alamosa,” the user only had to enter “HOLD 20 BEFORE ALS.” Thus, in this example disclosed in Riley, the important elements of the user's entry mimic the order of the same elements in the clearance.

The '892 patent utilizes a display, an input device, and a language parser/interpreter programmed to interpret various alternate expressions which have been entered into a predetermined format recognizable by a computer which is operable to display the parsed command and upon approval, to input the parsed command to the computer. However, one of the problems with the language parser utilized in, e.g., the '892 patent is that it may be difficult to update or adapt for new applications, languages, etc. Traditional models for language programming can be somewhat inflexible and not easy to adapt to a changing environment. It can be difficult to implement complex rules efficiently with traditional programming designs.

### SUMMARY OF THE INVENTION

The invention is based on the object of providing a natural language parser/interpreter that utilizes a hierarchical object model to provide flexibility and simplify complex rules and constraints of a particular system. The inventive parser is an interface between a user interface and an external system that the user interface communicates with, the inventive parser constraining the language passed to the external system so that only valid strings or commands are provided. The language processor also provides feedback to the user interface to assist the user in entering valid information.

Features of a user interface that permit easy input and output of information may be utilized; however, in the inventive system, it is important to distinguish between the user interface to a system and the interaction logic required by the system that addresses application-related levels of assistance; the user interface is made up of the physical displays and controls the user uses, such as CRTs, keyboards, mice, voice recognition and other input/output devices, and associated drivers, while the interaction logic governs how the interface and underlying system works.

The inventive language interpreter could be used in any system comprising a complex control, such as the cockpit control system described in the '892 patent above. However, the present invention is not limited to aircraft or vehicular applications; it can be utilized wherever any type of complex control mechanism is utilized or even wherever language is to be translated from one form to another or constrained in some manner.

The principal design concept includes the separation of functionality and the use of a hierarchical model for flexibility. The functionality is separated into input (where information is translated into objects or symbols), syntactic parsing, semantic parsing, and controller translation, which maps commands and symbols separately. Syntactic parsing is concerned only with the order of the symbol (or word), while semantic parsing refers to the actual logical values associated with each symbol or word.

Semantic checks occur after each object is added to the command object and possibly when the command object is thought to be complete before it is passed to the translator. Sets of syntactic and semantic rules are specific to each object in the hierarchy and are located in the DoME model with each object or are coded into or inherent to the chosen object model.

The inventive hierarchical model involves grammar creation, object class code generation, and the identification and translation of strings to objects. The inventive elements are described in more detail below. Although a specific embodiment of the invention is described below in its exemplary application to a user interacting with an FMS in a cockpit setting, the invention is to be construed more broadly, as indicated above.

The interface for this platform has been designed for maximum flexibility, but the real workload savings associated with the invention are due to the reduced cognitive effort of the user in trying to remember and follow the appertaining system rules and procedures. This system is ideal to enter even the most complex command strings, particularly when the entry concerns relate to the complexity of the functional logic. The system is designed to accommodate different grammar constructions, so the syntax of the interaction logic can be customized for different languages with relative ease.

This principle could apply where any type of language utilizes an existing body of user knowledge about a field, for example, knowledge of high level geometry and machine tool control-based languages for machinists when controlling numerically controlled machine tools, or knowledge of a process control language for manufacturing personnel for industrial processes. Even more broadly, this principle could apply in the simple transformation of language in one form to language in another.

### DESCRIPTION OF THE DRAWINGS

FIG. 1 is a block diagram showing the high-level data flow and data tables in the system;

FIG. 2 is a block diagram of the parser internal logic modules and their interactions with one another;

FIG. 3 is a flow diagram illustrating the pre-processing of strings;

FIG. 4 is a flow diagram illustrating the processing of strings;

FIG. 5 is a flow diagram illustrating the pre-processing of numbers;

FIG. 6 is a flow diagram illustrating the processing of a symbol using grammar;

FIG. 7 is a flow diagram illustrating adding a symbol;

FIG. 8 is a flow diagram illustrating adding a symbol to a temporary object; and

FIGS. 9A & 9B represent a flow diagram illustrating an execution of the send command.

### DETAILED DESCRIPTION OF THE INVENTION

System Architecture

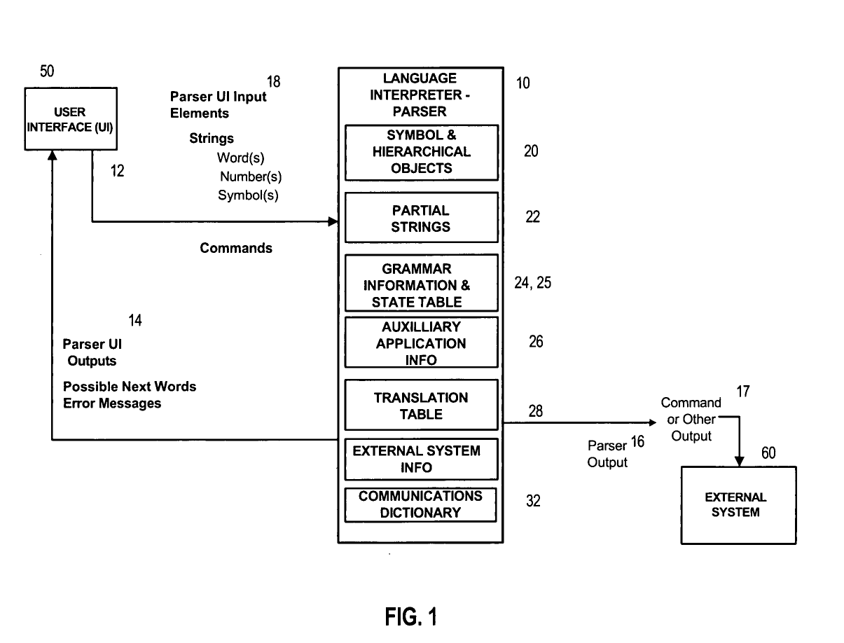

FIG. 1 illustrates an embodiment of the inventive language interpreter-parser 10. The language parser 10 interfaces with both a user interface 50, and an external system 60 that could be a controller, computer system, display, or other device that can accept a command or a constrained text string 17. In this context, the term “constrained text string” means any output that is understandable by the external system 60

The inventive language parser 10 is a constrained natural language parser that uses two primary semi-independent mechanisms: a grammar information 25 and state table 25 (these may be integrated and are indicated below, in places, in their integrated form), and a symbol and hierarchical object model 20. In addition to these two primary mechanisms, the parser 10 may include additional supporting elements. These elements may include one or more of a partial string buffer 22, auxiliary application information 26, a translation table 28, external system information 30, and a communications dictionary 32.

In a general sense, the grammar information and state table 24, 25 is used to provide a rigid set of constraints for the language that limit the language to that which can be understood by the external system 60. The object model 20 allows user input elements 18 to be manipulated into objects that can be interpreted correctly. These two primary mechanisms are interdependent of one another: the grammar portion 24 takes advantage of the object model 20 by relying on hierarchical definitions given to objects and their respective enumerations. Likewise the object model 20 relies heavily on the grammar information 24 to disallow many syntactically incorrect strings. Using this hybrid approach in the parser 10 maximizes the usefulness of the object oriented nature of commands/phrases and the flexibility of the syntax necessary for a language based interpreter, making changes or adaptations to different systems much simpler. The principal design concepts includes the separation of functionality and the use of a hierarchical object model for flexibility.

In an embodiment of the invention, an FMS application in which the external system 60 is a flight controller for an aircraft, the invention facilitates the use of the CCL used by the flight controller by implementing a constrained natural language parser 10 that allows a user to enter clearance elements for flight control in almost any order she wishes, as long as she follows legal English syntax and ATC phraseology. The CCL is a user-centered interaction concept for an autoflight system that any user can learn to use in about fifteen minutes.

In a broader sense, the invention facilitates the translation of language from one form to another and could be used to interface to a control or any other type of external system 60. By providing flexibility in command entry and providing contextual, syntactic, and grammatical assistance for entering information, the invention eliminates the need to learn and remember special operating rules for a particular interface making it easier for the user to enter commands in a manner which follows the operational logic used within the domain. The application is general enough so permit conformance of any user input to a constrained output in any form of a language understandable by the external system 60. This ease of learning and use is made possible by the fact that a language understood by the user (e.g., CCL) uses existing user knowledge about operating the external system 60 as the basis for the interaction logic. That is, the interaction logic of the system mimics the operational logic of the domain. Therefore, the user does not have to learn new operating logic for a complex system such as the automated control of any type of vehicle or machine or deal with modes management or other state-based aspects of the system when entering information directed to the external system 60.

The inventive language parser 10 has four primary functions: 1) to provide shortcuts for the user by automatically inserting implied words into the command or input string so that he or she does not have to enter redundant words; 2) to facilitate the resolution of ambiguities that may be present during entry; 3) to confirm the logical validity of the message and produce appropriate error messages for invalid strings; and 4) to prompt users by providing a list of next possible words, word phrases, or word completions during entry.

Although the language parser 10 is the primary focus of the invention, the following briefly describes the user interface 50 and the external system 60 to which the language parser 10 can interface.

The user interface 50 may comprise any known display unit such as a CRT, LCD/plasma panel, keyboard, mouse, text or character reader, barcode reader, speech recognition system, speaker, etc. In the FMS embodiment, the user interface 50 may comprise a control/display unit, a primary flight display, a multifunction display, a navigation display area, keyboards having alphanumeric keys or keypad, an option display area, a command display area, line select keys, option keys, a camera and/or voice input device that is possibly a microphone. The user interface 50 is used to transmit strings/partial strings and commands 18 into the language parser 10. The user interface 50 is also used to receive parser user interface outputs 14 (help, error messages, completions) and provide them to the user.

The external system 60 can be any system that utilizes parsed or constrained text as an input. The external system could be construed as broadly as a computer system or display mechanism, where the language parser 10 simply translates language from one form into another. The language parser 10 provides limitations and constraints based on the rules and syntax of a particular language. However, in a broadly construed embodiment, the external system 60 may be a control of some sort that accepts commands and acts on those commands. The language parser 10 then serves to provide only acceptable commands to the control 60 out of all possible language that a user might attempt to use to communicate with the control 60. In the narrower exemplary embodiment, the external system 60 may be a Flight Control System (as noted above), such as that described by the '892 patent. The external system accepts completed commands or other output 17 from the language parser 10 that is understandable by the external system 60.

In referring to the entities below, the word “table” may be used to describe a collection of one or more objects. A traditional table has often been construed as a database that would only contain data and that was distinct from the function modules that operated on the data. In the present description of the preferred embodiments, however, the words “table”, “object”, “database”, “buffer”, or other words referring to data may be implemented in an object-oriented manner, meaning that these entities may also contain functionality or program code that operates on respective data of an object. In other words, a “table”, as used below, may additionally contain functional code for operating on data stored in the table.

As noted above, the primary components of the interface-parser 10 itself are two semi-independent mechanisms: 1) the symbol and hierarchical objects table 20, and 2) the grammar information and state table 24, 25. In a basic sense, the symbol and hierarchical objects table 20 allows input command strings to be manipulated into symbol objects 80 that can be interpreted into their intents. The grammar table 24, 25 may be used to provide a rigid set of constraints for the language that maps to the language of the external system 60. In other words, the grammar information 24, 25 may contain all legal commands or words that can be used by the external system 60.

As FIG. 1 illustrates, the inventive language interpreter-parser 10 may utilize any number of additional databases or tables which may or may not be integrated into the parser 10 itself; however, those databases that are not integrated into the parser 10 may be readily accessed by the parser 10. A partial strings buffer 22 may be provided to temporarily hold partial strings that are input via the user interface 50 so that they may be analyzed and combined in a manner that will ultimately result in a completed object or output 17. This partial string only exists until a symbol (or multiple symbols) can be identified, formed and passed onto the next next legal string. The hold and temporary objects comprise one or more symbols.

Auxiliary application information databases 26 may be provided that contain information that is not used exclusively by the language parser 10, but rather provide relevant information that can assist the language parser 10 in formatting the command 17.

For example, in the exemplary system used for an FMS, the auxiliary application information 26 could be a navigational information database that comprises, e.g., locations of particular objects that might be used during flight, such as the airport name, airport objects, and waypoint objects, as well as possible completions for these elements. An FMS-EFIS shared memory update may include functions such as “get waypoint order number from flight plan”, “get origin airport”, “get closest airport waypoint order number”, and “get destination airport”. Obviously the navigation database would provide information to many other applications besides the FMS, and thus is not exclusively a part of the FMS. Use of the navigational information database in the FMS application could help the user to create a complete command 17 for the controller 60.

A control information database 30 may be provided that comprises information specific to a particular type of control or external system 60. This could permit various types of controls to be used with the same underlying software, and only this database might require updating in order to utilize a different control, and could constitute an FMS information database system for the FMS application.

A communications dictionary 32 may be provided that helps to ensure reliable data delivery. Although this dictionary could contain low level communication protocol data (e.g., related to TCP/IP, or even lower protocol level physical layer information), it is primarily concerned with reliable delivery at a higher level, i.e., ensuring valid commands make it to the external system 60 in a reliable manner.

The communications dictionary 32 may be implemented in the FMS application, as a Data Link dictionary 32 for Data Link communications that, for example, is based on standards such as specifications that are published by RTCA, Inc. “Minimum Operational Performance Standards for ATC Two-Way Data Link Communications” RTCA/DO-219, herein incorporated by reference.

To clarify how the communications dictionary 32 might operate in the FMS embodiment, the following exemplary description and interaction are provided. In this specific example, since a Data Link data dictionary 32 is a functional subset of CCL command strings (“Data Link” is a subset of ATC commands—and the CCL can handle any ATC command), CCL and Data Link are fully compatible. Having the Data Link interface incorporated into the CCL interface can allow a user to edit Data Link messages in the CCL environment. This, in turn, supports the ability to, e.g., negotiate clearances completely over Data Link.

For example, if the controller sends a clearance to an altitude that is higher than is possible due to weight, the user can copy the clearance into the CCL command string field, edit the altitude to a feasible value, and send the command string back to the controller as a request. Editing within the CCL environment retains the executable properties of the original message so that when confirmation is received from the controller, the command string can be executed directly, just as any Data Link message or CCL command string would be. For the FMS, CCL will continue to be necessary in the world of Data Link because when the user needs to enter a route modification manually, his use of Data Link as the primary mechanism of entering route data will prevent him from staying proficient at traditional CDU-based FMS operations, so ease of use for the FMS will be even more important than it is today. Furthermore, since CCL uses the same operational logic as Data Link (as both are based on ATC messages), Data Link messages actually reinforce the interaction logic of CCL, making manual and automatic operations essentially the same. This should enable users to stay proficient at lower levels of automation and manual data entry despite loss of continual practice.

This principle can be generalized by stating that when such a communications dictionary database (internal or external) 32 is used in conjunction with the language parser 10, information contained within the database can be utilized not only to assist in the entry of the proper information, but can also serve to reinforce knowledge about the logic of the applicable control or external system 60.

Grammar Information and State Table

The grammar information 24 and state table 25 are formed pre-runtime using a set of scripts and a look-ahead-one lexical interpreter; they contain all possible legal statements from the controller or external system's 60 perspective (of course, these statements do not comprise parameterized, categorical or numerical components of the legal statements since the tables would be too large). In order to create this table in the exemplary embodiment, research indicated that most commands contained a single action and target (or parameter variable), and a set of prepositions. The research also identified frequently used adjectives, adverbs, parameters, and conjunctions (see Table 1).

The language parser 10 was initially developed in the context of the FMS. In this development of the grammar (which was used to generate the state table 25), an initial set of command strings comprised a comprehensive list of common clearances; from those clearances, the CCL vocabulary was identified (i.e., which words represented actions and which words represented targets.) From this vocabulary, the original list of clearances, Data Link specifications, and from accepted ATC phraseology, a list of possible command strings was extrapolated to form the grammar.

Once the grammar has been defined, grammar information 24 from such strings can be created in a generalized sense by entering each of the command strings (or other type of output string, rule component, etc.) into a rule file in their general form/type as a verb, a target/parameter, and a list of possible prepositional phrases. Then, a program may be run that permutes the rule into all of the possible orderings. Each target and prepositional phrase may be individually defined, and (wherever possible) enumerations may be used to represent equivalent words and phrases.

The state table 25 may be constructed using rule permutations, noun rules and hierarchical representation. The grammar may be merged with the object mappings and transformed into a state machine 25 using any grammar state generation technique or tool (such as Bison). The state table 25 determines a particular state of a particular command line as it is being formed, such as whether the command is complete, what information it lacks, what options are available, etc. The state table is flexible as it can be utilized to check ahead and see if needed information can be anticipated. Thus despite being a look ahead one parser state machine, the parser can perform as a look ahead two or even look ahead k when necessary.

The rule permutations may utilize as many as 200 or more well-defined commands. The rule permutation also contains a list of word groupings that must appear together and in the order listed, as well as a list of prepositions and verbs, according to word types. The noun rules include the ordering of words or objects expected by a user and defines what each collection of objects map to. The hierarchical model includes a listing of hierarchical object relationships. The processing of grammar to Bison to state machine is completed by transforming the Bison output into a temporary file after insertions and then into a final parser-read grammar table.

This may be done with a series of scripts or other programs: The first script might mark word grouping. This allows for differentiation when the word order in the commands are critical, for example, “CLIMB AT 20NM” and “AT 20NM CLIMB.” Another script may flag the prepositions and verbs, and another script may take each flagged grouping and create all the possible permutations such that prepositional phrases can be placed in any order before or after the verb and it's target. After that is complete, the noun rules which define how a given target can be entered and the hierarchical object relationships may then merged with the permuted command list. This merged information is then passed into Bison to create a state machine in an output format particular to Bison. This format can then be modified as input for a parser by pulling out the state info along with the Bison rule list.

Substitutions may be utilized in this construction. In the FMS example, “when at”, “on reaching”, and “when reaching” can all be substituted for by “at” to create a command string with identical meaning. The grammar information and state table 24, 25 may be used at run-time both to ensure correctness of the strings entered and to prompt the user for possible next words. However, while the prompts are convenient, if the user wishes to enter only targets or to avoid some part of the command string, the object model may be used to determine the missing words or to prompt the user for an appropriate choice.

The state table 25 is bound tightly with the grammar table 24—the grammar information 24 holds all valid command objects that could be used on the controller, but the state table 25 might address this information in order to potentially modify the state of a particular command. The grammar information 25 may include the current state, current symbol object (in command, temporary, or hold object), command, temporary object (objects processed by grammar, but that cannot be added to the command), and hold object (objects that are legal to add to the command but have not been processed by the grammar). The distinction between a temporary object and a hold object can be illustrated as follows. For the command “TO FL320 AT KMSP”, the grammar expects: TO+FL+number. The command object expects Verb=TO; the cclTo object expects Target=Altitude, and the cclAltitude object expects Altitude Unit=Enumeration (FL) Value=number. So for “TO FL”, the grammar is okay and the temp object keeps “FL”, but for “TO FL320 KMSP”, the grammar is not okay and the hold object keeps “KMSP”.

Translation

The FMS translation involves the following. An FMS table is created to map FMS commands into a CCL equivalent. A translation table is created at startup to load the CCL equivalent in an n-airy tree for quick lookup. Inheritance and attribute mapping is used to find an equivalent CCL command from the FMS table. Since the CCL commands as objects are very specific, the equivalent of a CCL command can be found by climbing the hierarchical model and walking through the n-airy tree. At each terminal node, there is an FMS number that matches the CCL string and maps to one or more FMS commands. Data types may be filled with a translator object, and additional information is obtained from the database, if necessary.

Symbol & Hierarchical Object Model Table

The symbol table and hierarchical objects database 20 takes advantage of many common object oriented programming techniques (e.g., encapsulation, inheritance, and abstraction). Each word, partial word, number or phrase that is entered into the system, via any user input device 50, is transformed into a simple object that may be considered to be like a token, enumeration, or other form of object representation. This database 20 may contain objects that include tokenized enumerations of these partial words, words, numbers, and phrases (textual elements). The objects may then be combined together using the object model to create a single command object 84. Once the user input is transformed into an object format, then semantic checks, translation into external controller or system commands, or other types of operations can be performed on these transformed objects. The inventive parser 10 implementation creates an accurate and complete object model to capture the complexity of the natural language and the nuances of word ordering.

The object model is hierarchical in that an object-ordered hierarchy may be imposed on the structure of the objects. For example, at a low level, objects could broadly model words or partial words; at a next level, a more specific child object type may be modeled such as a noun, verb, parameter, etc.; the child object may inherit all or some of the properties of the parent “word” object that it is based on. At an even higher level, an object directed to, e.g., a location might be defined that inherits all or some of the properties of the “noun” object that it is based on. All of the tools of the object oriented programming methodology may be utilized and the advantages realized.

The implementation of an embodiment may be a file organized in an object-oriented manner according to: 1) grammar objects, 2) general objects, 3) control classes, and 4) interfaces.

The grammar objects may be organized into types such as verbs, conjunctions, prepositions and parameters (nouns). Many of these grammar objects would be relevant for a number of different implementations. In the FMS embodiment, these grammar objects may include:

TABLE 1

| | |
|---|---|
| Verbs: | Clear Copy Erase Expected Hide Inhibit Avoid |
| | Cross Follow |
| Conjunctions: | And AndThen |
| Prepositions: | Between From When Above After At AtOrAbove |
| | AtOrBelow Before Below For Of On Until |
| Parameters: | Degrees CardinalDirection LatitudeDirection |
| | LongitudeDirection Distance Frequency Channel |
| | Hours Minutes Leftright Lattitude Longitude |
| | Pressure Seconds Temperature Wind Target |
| | Adjective ArcTarget Arc AngleTarget Angle |
| | BankAngle Climb Angle |

The implementation of these objects may actually be a single class type which, when dynamically instantiated, reads it's object specific information from a database which was constructed on start up.

General objects may include symbol objects, number objects, an object list, and temporary objects used to store part of a command object when the command is not entered sequentially. These general objects may also be command objects (which may include a verb and a list of prepositions), compound command objects (which may include two command objects and one conjunction), return types (which may include a message or an error severity type), object pointers, and other types of traditional object-oriented object types. The control classes may include a symbol table 20, a grammar information 24 and a state lookup table 25, and elements of the language parser which may include the partial string and the Hold or Temporary Objects. The interfaces may include interfaces for the auxiliary application information 26, e.g., the navigation database interface 26, for the user interface 50, and for the external control or system 60, e.g., the FMS. These interfaces are designed to be base classes so that external changes to the system are isolated.

Software Configuration and Execution

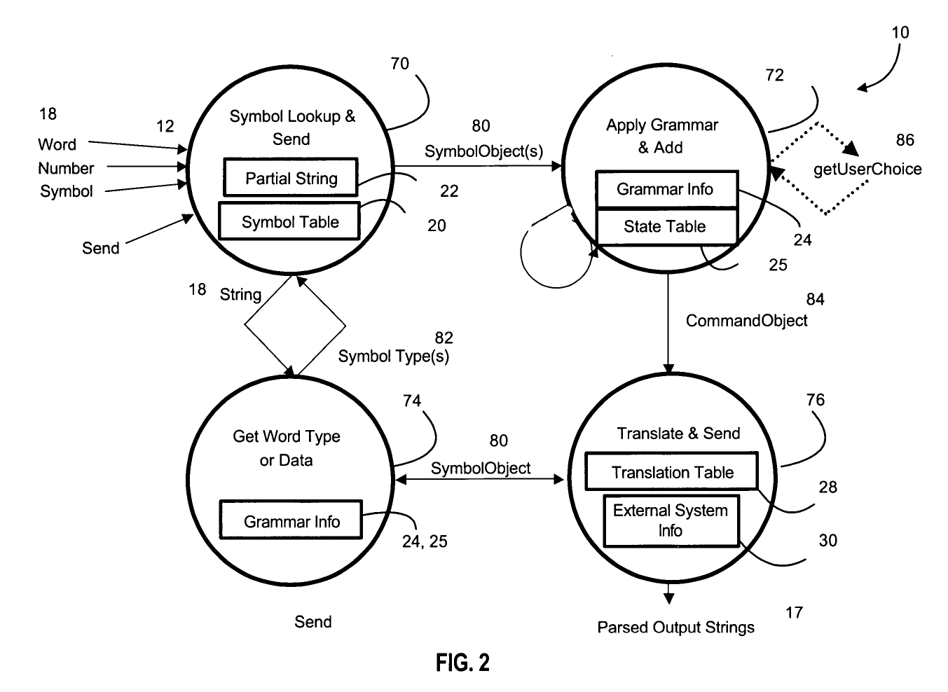

FIG. 2 illustrates an exemplary embodiment of the inventive language parser 10 comprising four internal logic blocks/modules: a symbol lookup and send module 70, an apply grammar and add module 72, a get word type or data module 74, and a translate and send module 76.

A discussion of the operation of these modules may best be illustrated by way of example. In the FMS embodiment, a user may wish to enter a command string that reflects a crossing restriction, “Cross MCW at or above FL210,” where MCW is a symbol for a location, and FL210 is a symbol for an altitude-this is the command string that would be provided to the FMS control 60. The user uses the user input device 50 to enter this command.

For pre-processing strings, a string or partial string is provided by the user. To initiate the above command string, a user might begin by either entering a “C” on an alphanumeric keypad, or by entering the entire word “cross” via any suitable input mechanism 50. This input 12 is initially handled by the symbol lookup and send module 70.

If a partial string “C” is initially entered via the input device 50, the “C” may be sent to the language parser 10 to be processed. The parser 10 generally performs string formatting that attempts to add/remove spaces, identify numbers, merge the partial string with old unprocessed strings, and checks with other databases. In this instance, the symbol lookup and send module 70 checks the partial string buffer 22 to see if there are any old unprocessed strings present. Since this is a new command, the partial string buffer 22 is empty, either because the last send command caused it to be cleared out or because of some form of initialization of this buffer 22.

Next, the symbol lookup and send module 70 tries to identify the input as a valid symbol object, utilizing the symbol table 20 (FIGS. 1 & 2). In general, the pre-processing of strings will either store a formatted input string as an unprocessed/partial string in the partial string buffer 22, will send it on for further number processing, or will send it on for further string processing. In the present example, the “C” is checked with the symbol table 20 that comprises possible words that may be used and may check with the grammar info 24 for those words that are legal (for this example those words that may start a command). A list of possible words beginning with “C” may be displayed to the user on the user interface 50 so that the user can select one of the words from a pick list. The user may complete the entry of the word “cross”, possibly by selecting the word from a list presented to her or by repeating the keyboard entry for the remaining letters. The communications from the user input device to the language parser in this embodiment may take place via a control abstraction layer simulation, although in a general sense, any known protocol may be used.

An attempt is made to translate the string into a symbol, e.g., to find the symbol for “cross”. If the translation fails, then an attempt is made to locate the object in the auxiliary application (FMS) info database 26. If the string cannot be found in the database 26 then it is stored as an unprocessed string and the user is issued a warning. Once the parser 10 processes the input “cross” and identifies this input as a valid symbol object using its symbol table 20, the word “cross” is identified as a particular symbol type 82 by the get word type or data module 74 based on the grammar information 24. The get word type module 74 receives a string 18 provided by the symbol lookup and send module 70 and returns an appertaining symbol type 82, (e.g., noun, verb, conjunction, preposition, parameter, enumeration) if found. If it is not found, then an error may be returned to the user or some other form of error handling invoked.

When the symbol lookup and send module 70 receives a symbol type 82, the parser 10 constructs a symbol object 80 and passes it to the apply grammar and add module 72 which processes the symbol object 80 against grammar rules stored in a grammar information table 24 and a state table 25 to create a command object 84. The apply grammar and add module 72 may check to see if there is a hold object waiting. If there is, the symbol object 80 may be added to the hold object and this combined object is processed as a symbol object 80 if no error occurs (otherwise, appropriate error handling is invoked). If there is no hold object waiting, then the grammar is checked to ensure the symbol can legally come next. If the grammar check is not successful, an attempt may be made to perform an auto-insertion of a conjunction or a verb. If this fails, a hold object may be created with the existing symbol, or the user may be prompted to enter a user-choice. If the grammar check is successful, then it is processed and the symbol added to the grammar.

In the present example, the “cross” symbol object is processed by the apply grammar and add module 72 against the grammar rules and state table to create a command object 84. At this point, the parser 10 can reduce the list of “possible next” words to only those that can legally follow “cross”, and optionally displays these to the user.

Next, the user may enter an “M” on the user input device, as a part of the navigational symbol “MCW”, and the symbol lookup and send module 70 is activated. As before, the parser 10 tries to identify the input as a valid symbol object. If it cannot, it stores the input as a partial string in the partial string buffer 22 and either waits for additional input or issues an error message. Once again, the parser 10 reduces the list of “possible next” words to only those that begin with an “M” and may display these to the user. The user may continue by entering “CW” on the keyboard. Again the parser 10 tries to identify the input as a valid symbol object and stores it as a partial string in the buffer 22, possibly adding the input string to the contents of the partial string buffer 22, and either waits for additional input or issues an error message. The parser 10 reduces the list of “possible next” words to only those that begin with “MCW”, and, in this exemplary instance, there are none, so the user interface displays no options.

Next, the user enters a space (“ ”), and the parser 10 tries to identify the input as a valid symbol object. In this case, “MCW” is passed to the get word type or data module 74 and, since this is not one of the normal command words, it is communicated to the translate and send module 76 where the auxiliary application information database 26 (in this case, the navigational database) is queried. “MCW” is found in this database 26 as a navigational symbol and the symbol and its type are returned. The parser 10 processes the symbol object against grammar rules 24 and a state table 25 in the apply grammar and add module 72 and adds the symbol (for “MCW”) to the previously created command object (“cross”) 84. The parser 10 can now reduce the list of “possible next” words to only those that can legally follow the resultant combined command object (“cross MCW”) and optionally display them to the user.

Next, in the example provided, the user enters “FL 210” on the user interface, which represents an altitude. The parser 10 processes the symbol object in the get word type or data module 74 against grammar rules 24 and a state table, but in this case, does not add the symbol to the previously created command object. Next, the user enters a space (“ ”), and the parser 10 processes the symbol object in the get word type or data module 74 against grammar rules 24 and the state table. At this point, the system cannot add the “FL 210” altitude symbol to the previously created command object, because a “user choice” is required to remove ambiguity (which invokes the get user choice routine 86).

The parser 10 produces a list of “insertion” words (e.g., above, after, after at, at, at and maintain, at or above, at or after, at or before, etc.) in the apply grammar and add module 72 since the altitude has not yet been added to the command object. These insertion words are displayed to the user. The user must then select one of these, or, alternately, the user can select “delete” or “clear” to clear out the contents, possibly via the keyboards.

In the example presented, the user enters “at or above”. The parser 10 processes the symbol object in the apply grammar and add module 72 against grammar rules 24 and the state table 25 and adds the symbol to the previously created command object. Again, the parser produces a list of “possible next” words.

The full string has now been entered, and the user enters “GO” to invoke the command string via a send command input 12. The parser 10 processes the command object 84. Using inheritance and attribute mapping, the command object 84 is identified as a crossing restriction and is translated by the parser 10 into a format that the controller 60 can implement as a flight change plan. The parser 10 may then produce a list of “possible next” words. If this is the end of the command, the parser may clear the display area of the user interface 50, the command string buffers, and other respective buffers of the system, and prepare to accept another command. Alternately, the user may delete or clear out the contents.

Inventive Method

The inventive system and a method of operation has been explained above with reference to two specific examples. The following describes the inventive method in a procedural manner. The inventive method comprises routines for: 1) pre-processing strings; 2) processing strings; 3) pre-processing numbers; 4) processing symbols using grammar; 5) adding a symbol; 6) adding a symbol to a temporary object; and 7) sending a command or output string. These routines are described in more detail and without reference to a particular example below. Except where noted, the pre-processing & processing of strings is performed by the symbol lookup & send subsystem 70 while the remainder of the processing functions are performed by the apply grammar & add subsystem 72.

Pre-Processing Strings

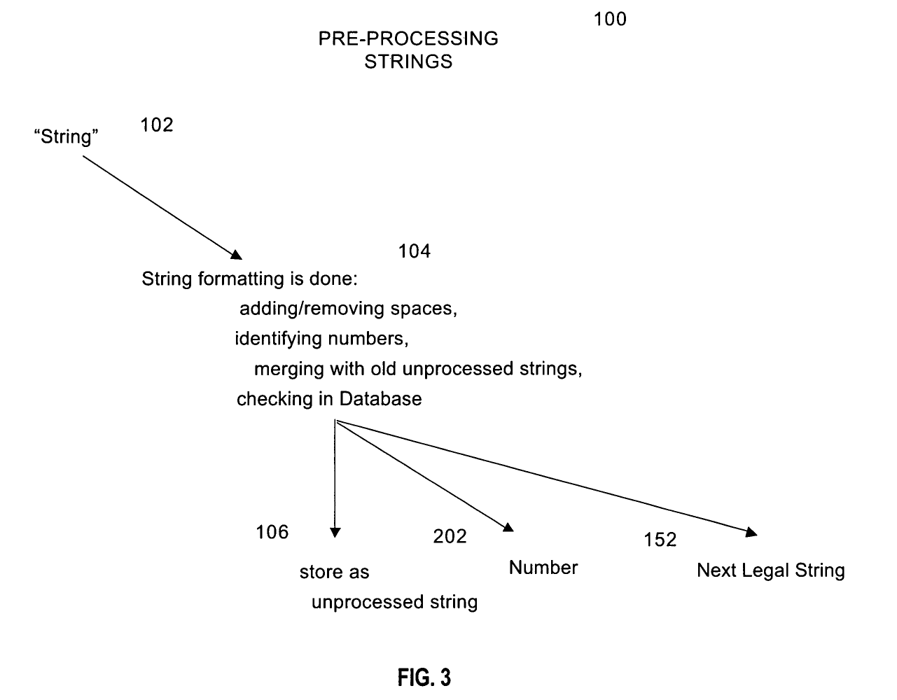

As indicated in FIG. 3, an input string 102, which are user input elements 18 is processed by one or more functions 104 that provide preliminary processing 100 of the input string 102. These functions 104 include adding and/or removing spaces in appropriate places, identifying numbers, performing merges with old unprocessed strings, performing a data base check (performed by the get word type or data subsystem 72 using the auxiliary application information database 26), and other functions. This can result in the pre-processed string being stored as an unprocessed string 106, being translated as a number 202, or being interpreted as a next legal string 152.

Processing Strings

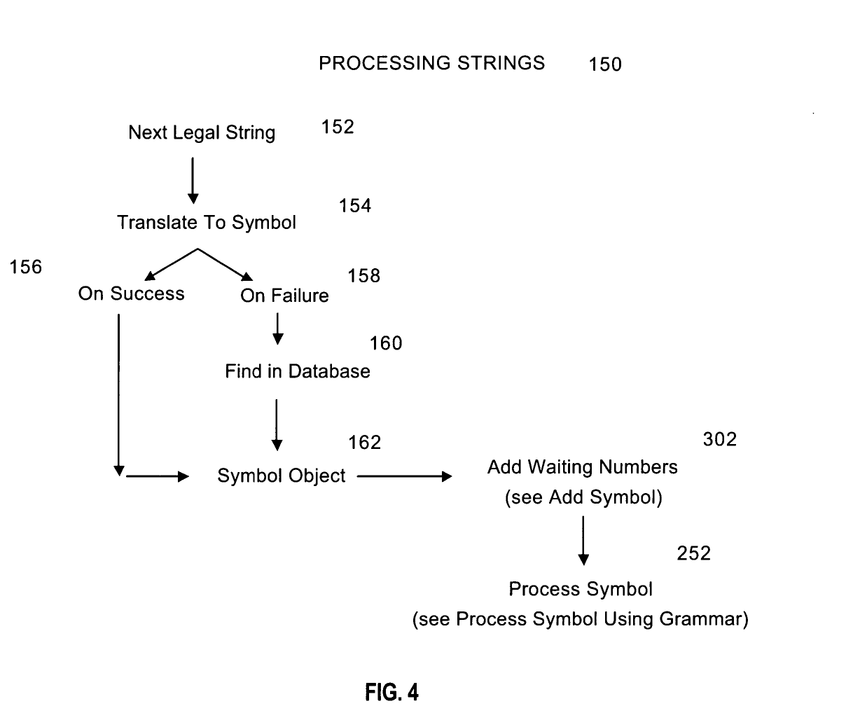

Upon completion of producing a next legal string 152 by the pre-processing routine, the processing of strings routine 150, according to FIG. 4, takes the next legal string 152 and attempts to translate it into a symbol 154. If this translation fails 158, a search is performed 160 (by get word type or data subunit 74 in the auxiliary application information database 26) to locate the symbol object 162. This database search 160 is not performed if the symbol translation 154 is successful 156. The symbol object 162 has any waiting numbers added to it 302 (as defined in more detail below), and this combination is then processed 252 as defined in more detail below by the process symbol using grammar routine.

Pre-Processing Numbers

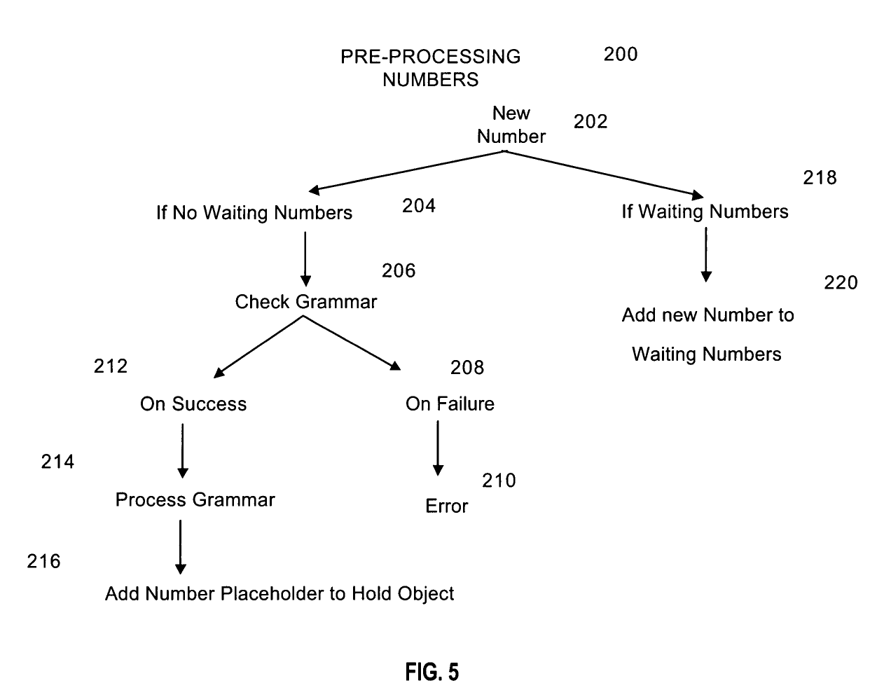

As indicated in FIG. 5, a new number 202 is provided to the pre-processing number routine 200 and a test is made to see if there are waiting numbers. If there are waiting numbers 218, the new number is added to the waiting number 220. Otherwise, a grammar check is performed 206. If this grammar check fails 208, then error processing is implemented 210, which may be in the form of an error message to the user. But if the grammar check 206 is successful 212, then the grammar is processed 214 and a number placeholder is added to the hold object 216.

Process Symbol Using Grammar

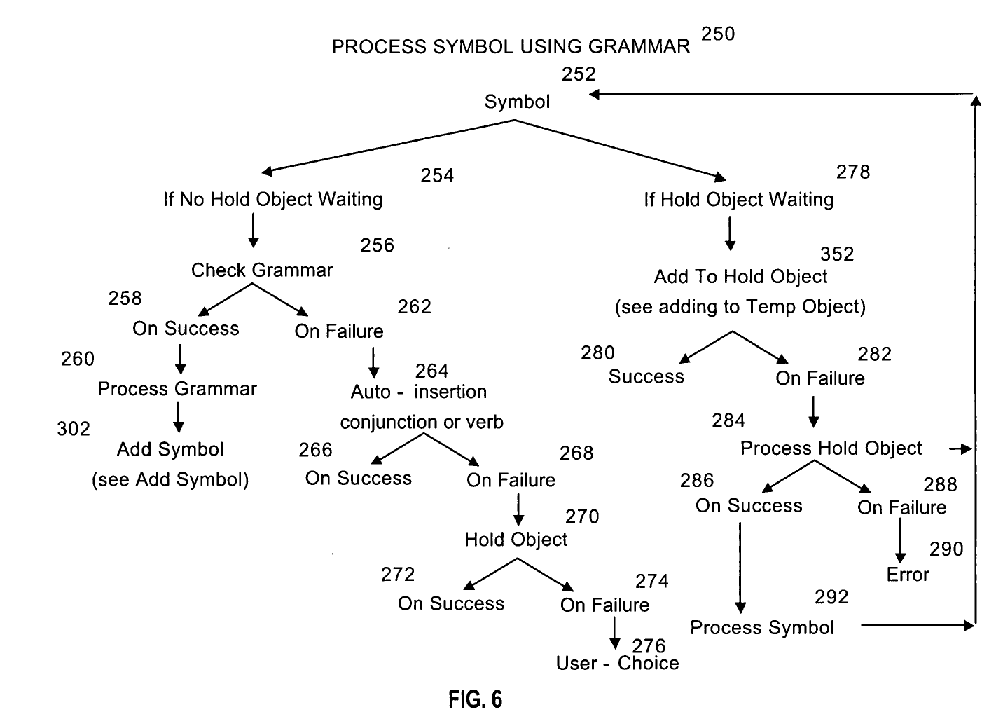

FIG. 6 illustrates the routine for processing a symbol using grammar 250. A test is made to determine if there is a hold object waiting 252. If so 278, an attempt is made to add the symbol to the hold object 352. This operation may result in success 280, but if it results in failure 282, an attempt is made to process the hold object 284. If this operation fails 288, then error handling is implemented 290. If it is successful 286, then this routine 250 is repeated.

Correspondingly, if there is no hold object waiting 254 when processing the symbol, then a grammar check is attempted 256. If this check is successful 258, then the grammar is processed 260 and the symbol is added 302, as described below. If the grammar check fails 262, then an attempt is made to auto-insert a conjunction or verb 264. This operation may result in success 266, but if it fails 268, an attempt is made to hold the object 270. The hold object attempt may be successful 272, but if it fails 2523, the user is requested to input a choice 276 which is accepted via the symbol lookup and send module 70.

Add Symbol

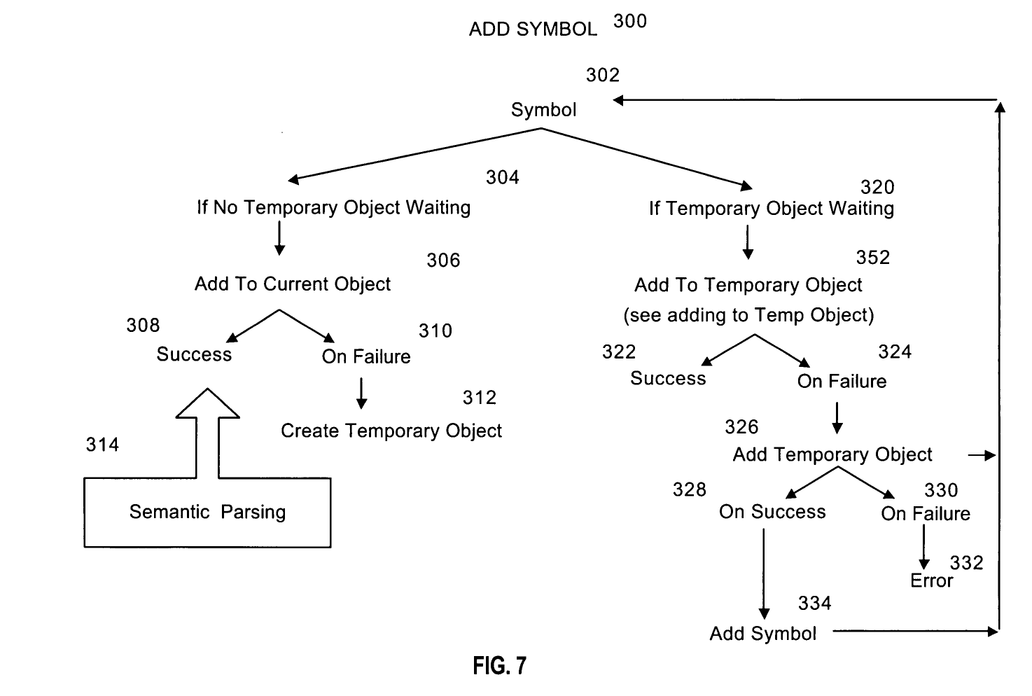

The addition of a symbol 300 is illustrated in FIG. 7. Similar to the previous routine, a test is made to see if there is a temporary object waiting 302. If there is no temporary object waiting 304, then an attempt is made to add the symbol to the current object 306. If it is successful 308, then this triggers the semantic parsing 314 which takes place after any new symbol is added to a command object or temporary object. If adding the symbol to the current object is not successful 310, then a temporary object 312 is created.

If a temporary object is waiting 320, then an attempt is made to add the symbol to the temporary object 352 that may succeed 322, or fail 324. On failure 324, an attempt is made to add a temporary object 326. If this add is successful 328, then the symbol is added 334 and the process is repeated 300.

Add Symbol to Temporary Object

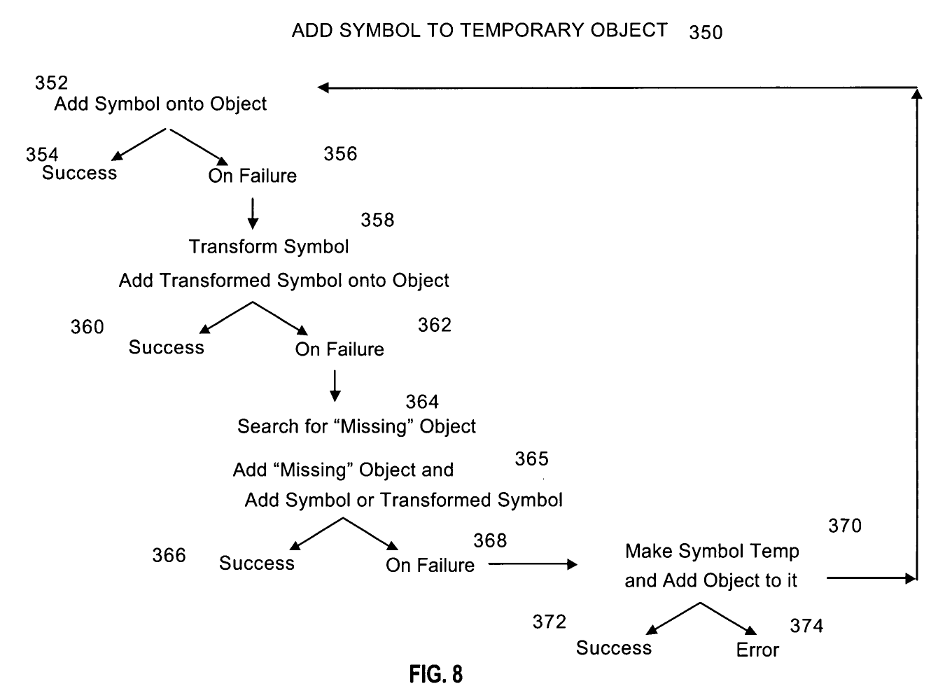

An attempt may be made to add a symbol onto an object 352 according to the add symbol to temporary object routine 350, as illustrated in FIG. 8. This attempt may be successful 354, or it may fail 356. If it fails, the symbol is transformed into it's parent object (using standard object oriented techniques) 358, and then an attempt is made to add the transformed symbol onto the object 358. This attempt may be successful 360 or it may fail 362. If it fails 362, a search is performed for the “missing” object which is able to add both the new or transformed symbol and the temporary object 364. An attempt is then made to try to add the “missing” object and add the symbol or transformed symbol 365. This attempt may be successful 366 or it may fail 368. If it fails 368, an attempt is made to make the symbol into a temporary symbol and to add the object to it 370, which may be successful 372 or may fail 374 in which case error handling is initiated. In any event, the routine 350 is repeated.

Send Command

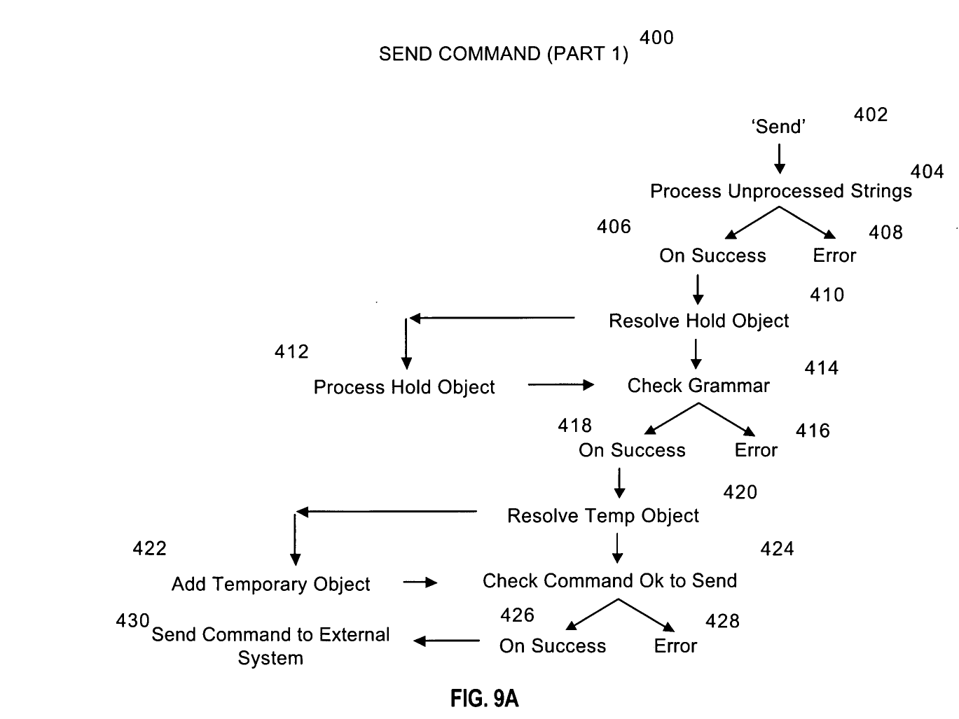

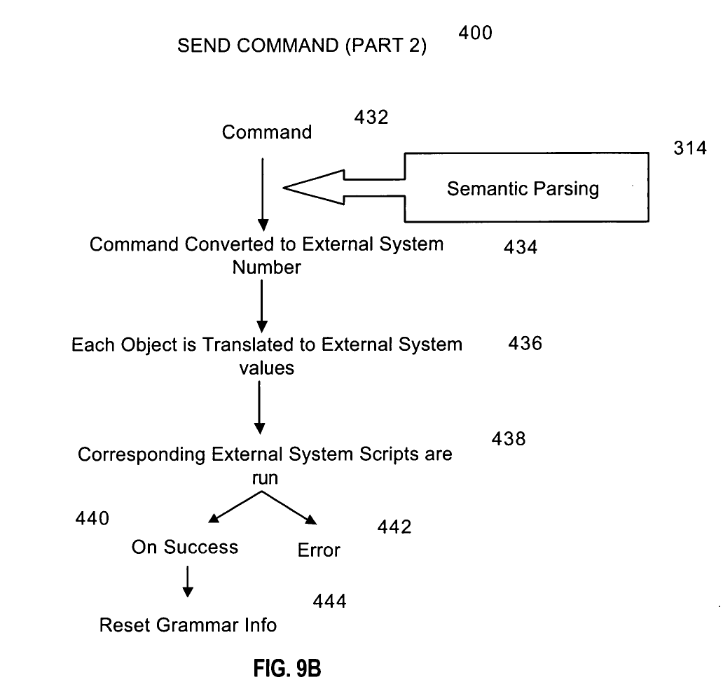

The send command handling 400 is illustrated in FIGS. 9A and 9B. As illustrated in FIG. 9A, invoking the send command 402 involves attempting to process unprocessed strings 404. If this attempt is not successful, then error handling is invoked 408. If it is successful 406, then a resolution on the hold object is implemented 410, with a possible operation of processing the hold object 412. In any event, the grammar is checked 414 and error handing is invoked 416 if this check is not successful. If it is successful 418, then a resolution of the temp object is performed 420, and, if appropriate, a temporary object is added 422. In any event, a check is performed to see if it is acceptable to send 424, and error handling is invoked if it is not 428. If it is okay to send 426, then the command is translated and sent to the external system 430.

FIG. 9B illustrates the processing of a command 432 that has undergone semantic parsing 314. The command is converted to an external system number 434, and each object is then translated to external system values 436. Corresponding external system scripts are then run 438 which may invoke error handling 442 if there are problems, or, on success 440, reset the grammar information 444.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

1. A natural language parser for accepting language input and producing a constrained language output, comprising:
an input configured to accept user input elements from a user interface comprising one or more of words, partial words, numbers, language symbols, and a send command;
an output configured to output completed syntactically correct parsed output strings to an external system;
a symbol table that is structured according to a hierarchical object model comprising multiple symbol objects representing possible valid user input elements, the symbol objects being based on an object-oriented-based hierarchical structure, wherein mapped symbol objects are mapped to the user input elements based on corresponding symbol objects of the symbol table and syntactic rules;
a grammar information and state table comprising:
multiple grammar output objects representing legal statements that may be used with the external system, the grammar information and state table providing a rigid set of constraints for the completed parsed output strings and disallowing syntactically incorrect strings, the grammar information and state table being utilized to create mapped output objects based on one or more of the mapped symbol objects in the hierarchically structured symbol table based on semantic rules, the grammar information and state table interacting with the symbol table to disallow syntactically incorrect user input elements; and
a state table configured to reflect a state of a particular output as it is progressively entered by the user;
the natural language parser further comprising;
a translator comprising a translation table having an output object to output string mapping, the translator configured to combine information from the translation table and the output object to produce the parsed output strings.

2. The parser according to claim 1, wherein:
the external system is a controller for at least one of a vehicle, a machine, and a system.

3. The parser according to claim 2, wherein the vehicle controller is an aircraft FMS controller, and the parsed output strings are FMS commands.

4. The parser according to claim 1, wherein the grammar information and state table comprises word types that include one or more of verbs, prepositions and adjectives.

5. The parser according to claim 1, wherein the multiple symbol objects comprise grammar objects, general objects, control classes, and interfaces.

6. The parser according to claim 5, wherein the interfaces comprise an application auxiliary information interface, and an external system interface.

7. The parser according to claim 6, wherein the application auxiliary information interface is a navigation database information interface, and the external system interface is an FMS interface.

8. The parser according to claim 5, wherein:
the control classes comprise a symbol type list, a grammar and state interface, and a state lookup table;
the general objects comprise symbol objects, number objects, an object list, and temporary objects; and
the grammar objects comprise verbs, conjunctions, prepositions and parameters.

9. The parser according to claim 1, wherein the grammar information and state table is configured to map at least two different user input elements to a single same mapped command object.

10. The parser according to claim 1, further comprising:
a partial string buffer configured to hold user input elements until at least one of a mapped symbol object and a mapped command object is formed.

11. The parser according to claim 1, wherein:
the input is configured to accept input from more than one user interface device; and
the parser is configured to combine user input elements from two or more user interface devices into a single parsed output string.

12. A method for parsing a user-supplied language input and providing a parsed output for an external system, comprising:
providing a natural language parser comprising a user input that accepts user input elements from a user via a user interface, the parser further comprising an output that outputs parsed output strings to an external system;
building a symbol table that is part of the parser according to a hierarchical object model structure by entering into the symbol table symbol objects that correspond to valid user input elements and include symbol object type information;
building a grammar information and state table by providing multiple grammar output objects that correspond to valid parsed output strings of the external system;
building a translator by providing output strings corresponding to the command objects;
entering user input elements into the user input by a user;
converting the user input elements into mapped symbol objects corresponding to the user input elements utilizing the symbol table and syntactic rules;
converting one or more of the mapped symbol objects into a corresponding mapped output object utilizing the grammar information and state table and based on semantic rules, and updating a state of a mapped output object in the state table;
constraining user input elements as they are being entered by checking the grammar and information state table, the symbol table, the syntactic rules, and the semantic rules, and providing information back to assist the user in entering proper user input elements;
receiving a send command as a user input element;
translating, in response to receiving the send command, the mapped output object into a corresponding parsed output string utilizing the translator; and
sending the parsed output string to the external system.

13. The method according to claim 12, wherein constraining user input elements comprises:
providing to the user via the user interface at least one of a pick list of valid next inputs, a help message defining a type of valid next input, and an error message indicating a problem with user entry;

14. The method according to claim 12, wherein building the grammar information and state table comprises identifying a comprehensive set of output strings for the external system, entering the command strings into a rule file in their general form, parameter, and list of possible prepositional phrases, and the permutations of the rules into all possible orderings.

15. The method according to claim 12, further comprising:
providing to the user a graphical representation of grammar objects and their relationships to one another that relate to function, semantic restrictions, and default information for auto-insertion or creation.

16. The method according to claim 12, further comprising:
inserting, for the user, user input elements when the user does not follow proper grammar; and
prompting the user for a user input element required for a parsed output string.

17. A method for parsing a user-supplied language input and providing a parsed output for an external system, comprising:
pre-processing user input elements as input strings by storing pre-processed strings as an unprocessed string, performing number handling, or processing strings by performing next legal string handling;
processing the unprocessed string by the next legal string handling into a mapped symbol object based on corresponding symbol objects of a symbol table;
pre-processing input numbers by the number handling and adding a number placeholder to a hold object representing a current state of a command object;
processing the mapped symbol object that results in at least one of: a) combining the mapped symbol object with the hold object, b) providing an error message to the user interface, c) automatically inserting a conjunction or verb, d) providing the user with a choice list of possible next entry values, e) locating and adding a missing object to the current state of the command object, and f) adding the mapped symbol object to the current state of the command object;
processing a user entered send command that combines any unresolved mapped symbol objects with the current state of the command object, producing a completed valid command object;
translating the completed valid command object into a parsed output string; and
sending the parsed output string to the external system and resetting the current state of the command object.
